(19) United States
(12) Patent Application Publication
(10) Pub. No.: US 2010/0094823 A1
(43) Pub. Date: Apr. 15, 2010

(54) ENHANCED LINEAR PRESENTATION OF SEARCH RESULTS BASED ON SEARCH RESULT METADATA

(76) Inventor: Mathieu Lemaire, Paris (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/250,733

(22) Filed: Oct. 14, 2008

(51) Int. Cl. G06F 17/30

(52) U.S. Cl. 707/705; 707/E17.014

(57) ABSTRACT

Some aspects include reception of a search result associated with a first value of a first type of metadata and a second value of a second type of metadata, and creation of a view comprising a graphical indication of the search result at coordinates (A₁, B₁) of a coordinate system comprising axis A and axis B. The coordinate A₁ is based on the first value and the coordinate B₁ is based on the second value.

In some aspects, a search result is received that is associated with a first value of a first type of metadata and a second value of a second type of metadata, and a view is created comprising a graphical indication of the search result at coordinate A₁ of axis A. The coordinate A₁ is based on the first value and a size of the graphical indication is based on the second value.

### BACKGROUND

Systems to provide electronic searching of information are well known. Generally, a client transmits search terms to a search engine and receives search results in response. The search engine may search any type of data and/or database structure in order to generate the search results. Conventionally, an index is created based on selected data sources and the search engine searches the index based on the search terms.

Each of the search results received by the client identifies an electronic item (e.g., a Web page, a document, a report, a personal profile). Each search result also includes metadata describing the search result. The metadata may include a title of the item, a measure of the relevancy of the search result to the search terms, a creation date of the item, or the like.

Search results are typically displayed in a list format, in order of relevancy. Identifying a desired search result from such a list can be inefficient, particularly in a case that the user is interested in a metadata type other than relevancy. Some systems allow a user to reorder the list based on an alternative type of metadata, such as item creation date. In other systems, the user can filter the search results by one or more types of metadata to eliminate unwanted search results (e.g., creation date>two months ago) from the list.

Systems are desired for improving the presentation of search results.

### BRIEF DESCRIPTION OF THE DRAWINGS

FIG. 1 is a view of search results according to some embodiments.

FIG. 2 is a flow diagram of a process according to some embodiments.

FIG. 3 is a block diagram of a system according to some embodiments.

FIG. 4 is a block diagram illustrating a relationship between search result metadata and display characteristics according to some embodiments.

FIG. 5 is a view of search results according to some embodiments.

FIG. 6 is a flow diagram of a process according to some embodiments.

FIG. 7 is a view of search results according to some embodiments.

FIG. 8 is a view of search results according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

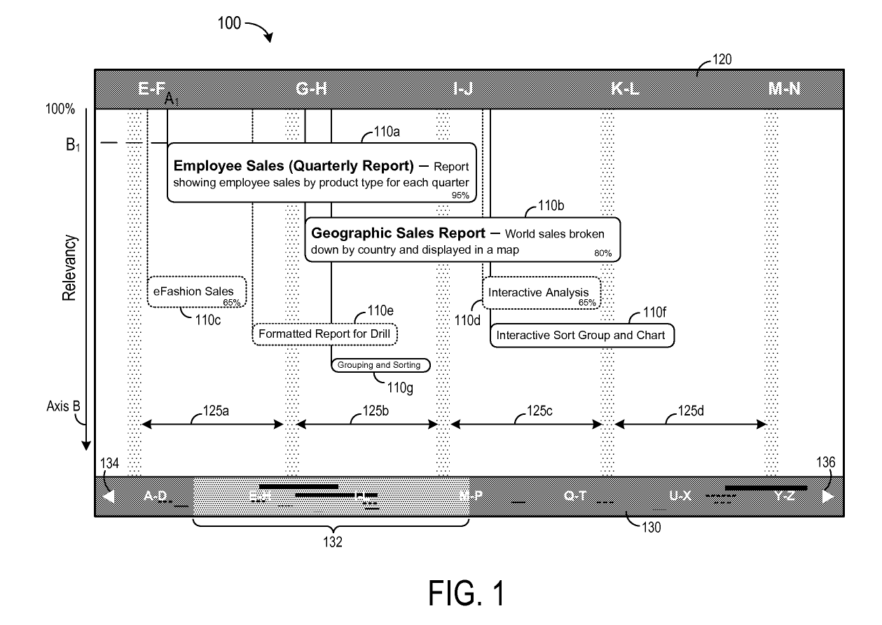

FIG. 1 illustrates view 100 according to some embodiments. View 100 may be presented by any display system that is or becomes known, some examples of which are provided below. View 100 may be presented to a user in response to submission of a search query.

View 100 includes graphical indications 110a through 110g, each of which corresponds to a respective search result. Each search result, in turn, is associated with at least two types of metadata. Moreover, each search result is associated with a value for each of the at least two types of metadata. For example, graphical indication 110a is associated with title type metadata (value=“Employee Sales (Quarterly Report)”) and a relevancy type metadata (value=95%).

Within view 100, graphical indication 110a is located at coordinates (A₁, B₁) of a coordinate system comprising axis A and axis B. Axis A is represented by graphical bar 120, which denotes regions 125a through 125d. As shown, region 125a of the A axis is associated with values of the title type metadata beginning with “E’ and “F’. Graphical indication 110a is therefore present at coordinate A₁ because the value of the title type metadata associated with the search result (i.e., “Employee Sales (Quarterly Report)” is equal to one of the values (i.e., “first letter E”) associated with region 125a.

Similarly, the coordinate B₁ is based on the value of the relevancy type metadata associated with the search result. Axis B is not shown in view 100 but is represented adjacent thereto for explanatory purposes. Embodiments may or may not include a representation of axis B or of any other axis described herein. Points along axis B are associated with decreasing values of relevancy type metadata. In the present embodiment, coordinate B₁ is associated with a relevancy value equal to the relevancy value (i.e., 95%) associated with the search result represented by graphical indication 110a. In some embodiments, axis B may consist of regions as described above with respect to axis A, with each region associated with more than one relevancy value. Graphical indications of search results associated with any of the more than one relevancy values of a region may be positioned at any B coordinate in the region in some embodiments. Alternatively, such graphical indications may each be positioned at a same B coordinate.

Accordingly, a horizontal position of indication 110a represents a first letter of the associated search result's title, and a vertical position of indication 110a represents a relevancy of the associated search result. Of course, some embodiments may use vertical positioning to represent a first letter of an associated search result's title (or any other type of metadata) and horizontal positioning to represent relevancy (or any other type of metadata) of the associated search result. In this regard, embodiments are not limited to horizontal and vertical positions.

FIG. 1 shows an upper left-hand corner of graphical indication 110a positioned at coordinates (A₁, B₁). Embodiments are not limited thereto. References herein to positioning a graphical indication “at” a coordinate may indicate that some portion of the graphical indication is located at the coordinate.

Continuing with FIG. 1, the value of the title type metadata associated with the search result of graphical indication 110b is “Geographic Sales Report”. Geographical indication 110b is positioned in region 125b of axis A because the first letter of this metadata value is equal to one of the values (i.e., “G”, “H”) associated with region 125b. Positioning along axis A in this example may be continuous (i.e., a document entitled “ABC” is positioned to the left of a document entitled “ABD”. Geographical indication 110b is positioned at a B coordinate that is associated with a value (i.e., 80%) of its associated relevancy type metadata.

Similar descriptions apply to graphical indications 110c through 110g. Graphical indications 110e through 110g do not indicate associated relevancy values due to space constraints. In this regard, the appearance, shape, sizes, and displayed information of graphical indications 110a through 110g are not limited to the illustrations herein.

According to the FIG. 1 embodiment, a size of each of graphical indications 110a through 110g is based on the relevancy value of the associated search result. Each different relevancy value may correspond to a different size, or each size may correspond to a range of relevancy values. In this regard, graphical indication 110b is smaller than graphical indication 110a and larger than graphical indication 110d because a relevancy value associated with graphical indication 110b is smaller than a relevancy value associated with graphical indication 110a and larger than a relevancy value associated with graphical indication 110d. “Size” as used herein may refer to any dimension, including but not limited to height, width and area. View 100 thereby indicates relevancy values of each represented search result through horizontal position and size of the associated graphical indications.

Each of graphical indications 110a through 110g also represents a value of category type metadata associated with a respective search result. Search results of a first category value are represented by graphical indications having a solid border (i.e., 110a, 110b, 110f and 110g), and search results of a second category value are represented by graphical indications having a dotted border (i.e., 110c, 110d and 110e). Category values may be represented by a graphical indication in any suitable manner, including but not limited to color, animation, font, etc. Moreover, such representations are not limited to category values and may reflect values of any metadata type.

Distribution bar 130 of view 100 represents the category values, relevancy values, and title values associated with each represented search result. Each graphical indication is represented by a line within bar 130. A thickness, a length and a vertical position of each line each represent a relevancy value, a format (solid, dotted, dashed, etc.) represents a category value, and a horizontal position represents a title value of an associated search result. Highlighted portion 132 indicates the spectrum of graphical indications displayed above distribution bar 130. Arrows 134 and 136 may be operated to move highlighted portion 132 and to thereby scroll through the graphical indications represented in distribution bar 130.

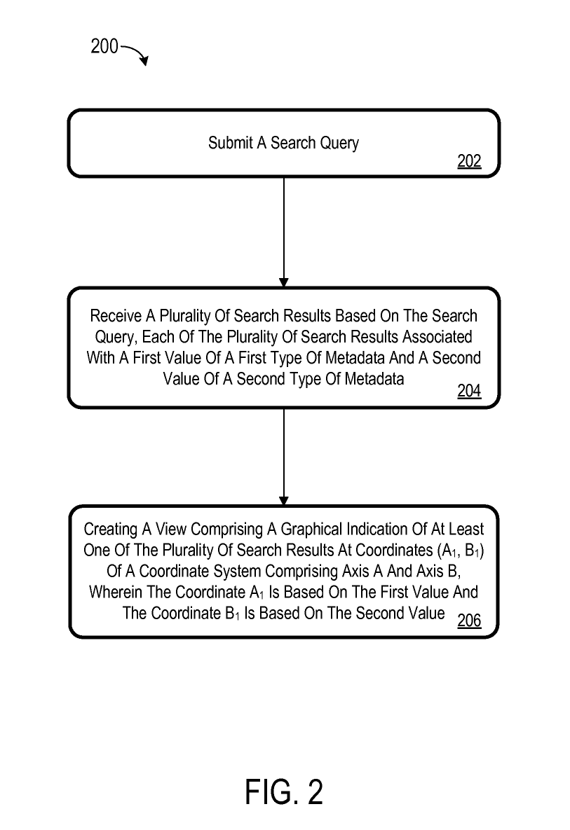

FIG. 2 is a flow diagram of process 200 according to some embodiments. Process 200 may be executed by hardware and embodied in program code stored on a tangible computer-readable medium. Process 200 may result in view 100, but embodiments are not limited thereto.

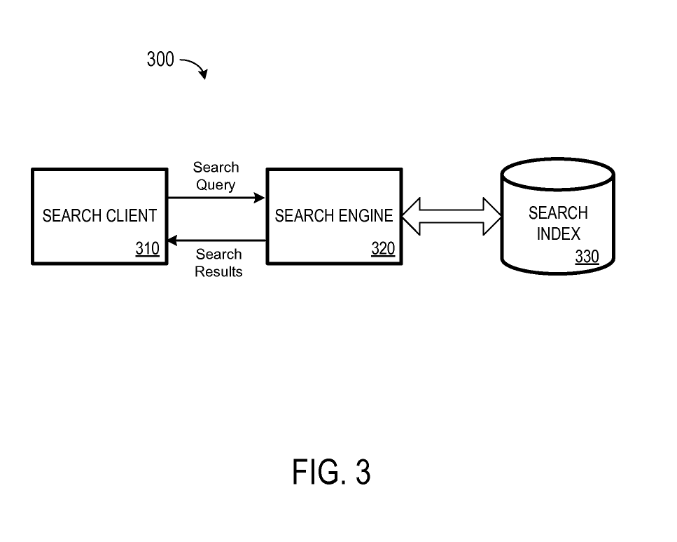

A search query is initially submitted at 202. The search query may be submitted by any type of search client to any type of search result provider using any querying protocol that is or becomes known. System 300 of FIG. 3 is a simple block diagram illustrating an architecture to implement process 200 according to some embodiments. As shown, search client 310 transmits a search query to search engine 320 at 202.

Search client 310 may comprise any suitable device, such as a desktop computer, a laptop computer, a personal digital assistant, a tablet PC, and a smartphone. Search client 310 may execute program code of a rich client application, an applet in a Web browser, or any other application to perform the processes attributed thereto herein.

Search engine 320 receives the search query and formulates search results according to any known, proprietary, or other procedure. Such a procedure may include acquiring data from search index 330. Search index 330 may provide an index of searchable items (e.g., a Web page, a document, a report, a personal profile) and metadata values associated with each item. Search engine 320 may assist in the creation of search index 330. Embodiments may operate in conjunction with any system for providing search results.

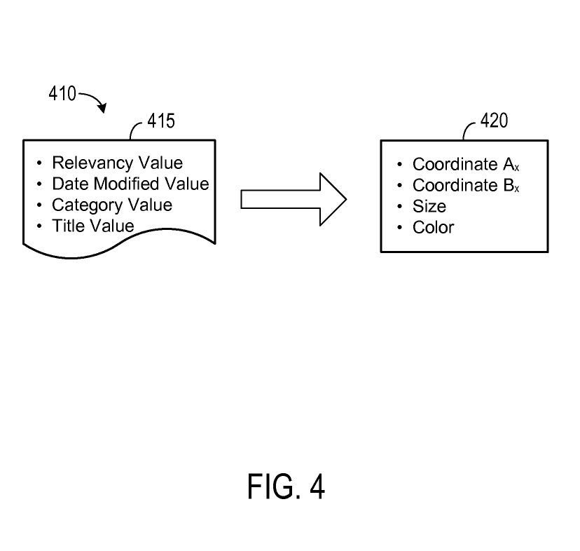

A plurality of search results are received at 204 based on the submitted search query. Each of the plurality of search results is associated with a first value of a first type of metadata and a second value of a second type of metadata. FIG. 4 illustrates one of the plurality of search results according to some embodiments. Search result 410 includes item 415 which is a pointer (e.g., a hyperlink) to an actual item (or the item itself) that was identified by search engine 320 in response to the search query. Item 415 is associated with several metadata values, each of which corresponds to a particular type of metadata. FIG. 4 depicts values of relevancy type metadata, date modified type metadata, category type metadata, and title type metadata, but embodiments are not limited thereto.

Next, at 206, a view is created including a graphical indication of at least one of the plurality of search results. The graphical indication is located at coordinates (A₁, B₁) of a coordinate system comprising axis A and axis B. As described with respect to view 100, the coordinate A₁ is based on a first value of the first type of metadata and the coordinate B₁ is based on a second value of the second type of metadata.

FIG. 4 also illustrates determination of coordinates of graphical indication 420 at 206 based on two types of metadata values. A size and a color of graphical indication 420 are also determined at 206 according to some embodiments. As mentioned above, the coordinates, sizes and colors may be determined based on any respective types of metadata. Moreover, two or more characteristics of a graphical indication (e.g., coordinate B and size, as shown in view 100) may be determined based on a single type of metadata.

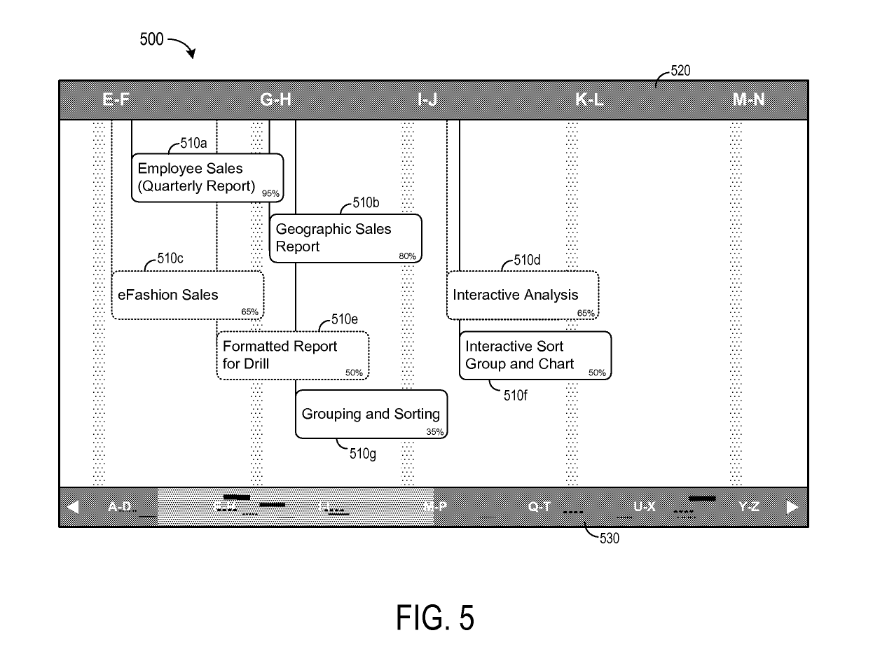

FIG. 5 shows view 500 created according to some embodiments of process 200. Graphical indications 510a through 510g are positioned along axis A (i.e., bar 520) based on their respective title type metadata values, and along axis B based on their respective relevancy type metadata values. Moreover, a border style of each of graphical indications 510a through 510g represents an associated category type metadata value.

However, each of graphical indications 510a through 510g exhibits a same size as each other of graphical indications 510a through 510g. Accordingly, a relevancy value of each of graphical indications 510a through 510g is represented only by vertical position (i.e., coordinate Bₓ). Distribution bar 530 also differs from distribution bar 130 to reflect the equal widths of each of graphical indications 510a through 510g.

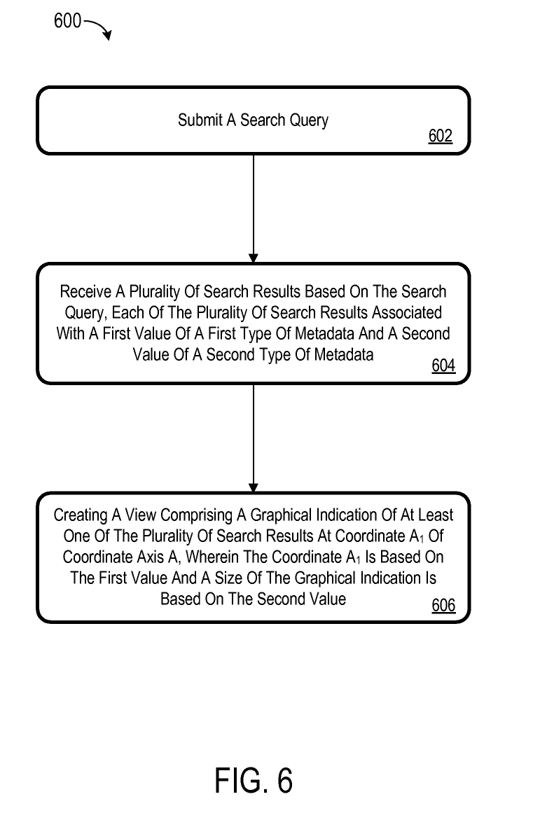

FIG. 6 illustrates process 600 according to some embodiments. Process 600 may result in view 100, but not in view 500, in some embodiments as will be described below.

602 and 604 of process 600 may be performed by system 300 as described with respect to 202 and 204 of process 200. Embodiments are not limited to such an implementation.

An entity (e.g., search client 310) receiving the plurality of search results at 604 may create a view at 606. The view may include a graphical indication of one of the plurality of search results at coordinate A₁ of coordinate axis A, wherein the coordinate A₁ is based on a first value of a first type of metadata associated with the search result. A size of the graphical indication is based on a second value of a second type of metadata associated with the search result.

As mentioned, view 100 may be created at 606 according to some embodiments. Specifically, each of graphical indications 110a through 110g of view 100 is positioned at a coordinate of axis A (i.e., bar 120) according to a value of title type metadata associated with the graphical indication. A size of each of graphical indications 110a through 110g of view 100 is based on an associated value of relevancy type metadata.

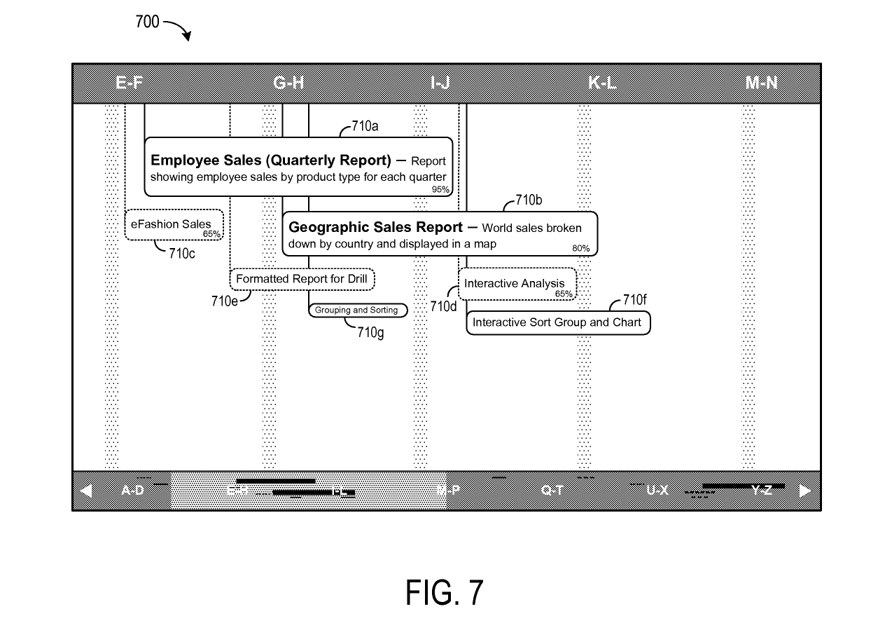

View 700 of FIG. 7 is another version of a view that may be created according to some embodiments of 606. For example, each of graphical indications 710a through 710g of view 700 is positioned along graphical bar 720 according to an associated value of title type metadata, and a size of each of graphical indications 710a through 710g is based on an associated value of relevancy type metadata.

In contrast to view 100 and view 500, a vertical position (e.g., along axis B) of graphical indications 710a through 710g is not based solely on a value of associated relevancy type metadata. Rather, each of graphical indications 710a through 710g is located at a highest available vertical position that avoids overlap with another graphical indication. Such an arrangement may result in a graphical indication associated with a first relevancy value (e.g., graphical indication 710c) having a same (or higher) vertical position as a graphical indication associated with a second, greater, relevancy value (e.g., graphical indication 710b).

Potential overlaps are resolved by positioning the potentially-overlapping graphical indications according to relevancy. In this regard, graphical indication 710a is positioned above graphical indication 710c because these graphical indications occupy a common region of axis A and because a relevancy value associated with graphical indication 710a is greater than a relevancy value associated with graphical indication 710c.

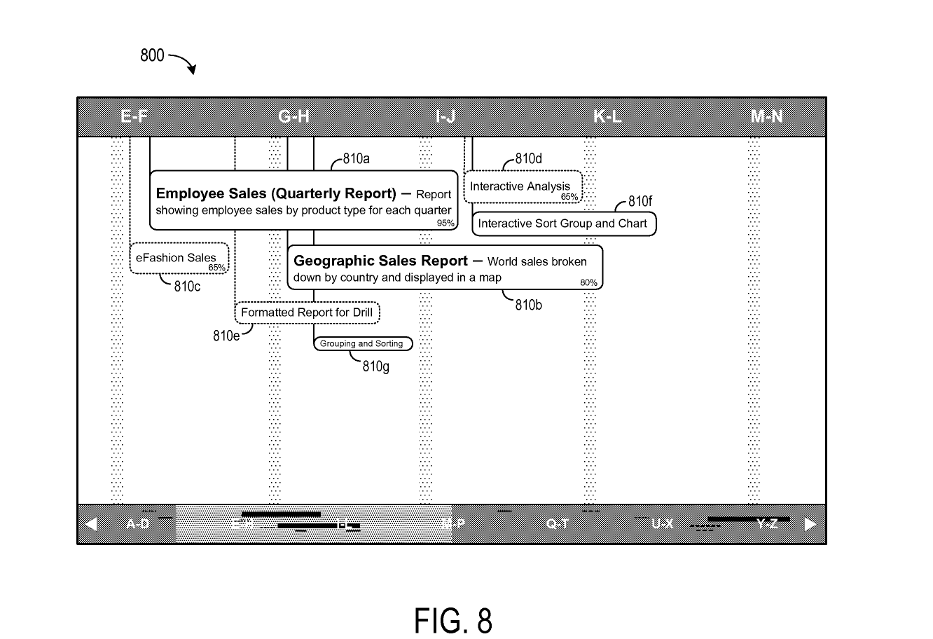

FIG. 8 illustrates yet another view 800 according to some embodiments of process 600. View 800 is similar to view 100 and view 700 in that a size of each of graphical indications 810a through 810g is based on an associated value of relevancy type metadata. Similarly to view 700, each of graphical indications 810a through 810g is located at a highest available vertical position that avoids overlap with another graphical indication. However, potential overlaps of graphical indications in view 800 are resolved based on available space considerations. Accordingly, graphical indications 810d and 810f are positioned above graphical indication 810b, even though graphical indication 810b is associated with a greater relevancy value. View 800 therefore provides a more compact arrangement than view 700, but fewer visual indications of relative relevancy.

Each of the above-described views is based on a same set of search results and associated metadata values. According to some embodiments, a user may issue a command to change from any of the above-described views to any other of the above-described views. Additionally, a user may issue a command to change the type of metadata with which the A coordinate, the B coordinate, or the size of the graphical indications is associated. For example, a user viewing view 100 may issue a command to associate axis A with a Date Modified type metadata. Client device 310 may, in response, create a new view in which the A coordinate of each of graphical indications 110a through 110g is based on its Date Modified value. Graphical bar 120 and distribution bar 130 of the new view would therefore reflect dates instead of alphabetic characters. The B coordinate (and/or the size) of each of graphical indications 110a through 110g may remain based on its associated relevancy value.

Although the foregoing examples are related to the display of search results, embodiments are not limited thereto. Embodiments may include querying a semantic layer of an enterprise system, receiving objects and measures in response, and creating views including graphical indications based on the measures. For example, embodiments may include a view comprising graphical indications of personal contacts (e.g., stored locally as .vcf files) at coordinates (A₁, B₁), where one of coordinates A₁ or B₁ and/or a size of a graphical indication is based on the number of mails exchanged with the corresponding contact. In another example, a view may include graphical indications of all sales associated with a sales representative at coordinates (A₁, B₁), where one of coordinates A₁ or B₁ and/or a size of a graphical indication is based on a total revenue associated with the corresponding sale.

The embodiments described herein are solely for the purpose of illustration. Those in the art will recognize that other embodiments may be practiced with modifications and alterations limited only by the claims.

What is claimed is:

1. A method comprising:
receiving a search result associated with a first value of a first type of metadata and a second value of a second type of metadata; and
creating a view comprising a graphical indication of the search result at coordinates (A₁, B₁) of a coordinate system comprising axis A and axis B,
wherein the coordinate A₁ is based on the first value and the coordinate B₁ is based on the second value.

2. A method according to claim 1,
wherein the coordinate A₁ is a point in a region of the A axis, wherein the region of the A axis is associated with one or more values of the first metadata, and wherein the first value is equal to one of the one or more values of the first metadata associated with the region of the A axis.

3. A method according to claim 2,
wherein the point in the region of the A axis is associated with the one of the one or more values of the first metadata which is equal to the first value.

4. A method according to claim 2,
wherein the coordinate B₁ is a point in a region of the B axis, wherein the region of the B axis is associated with one or more values of the second metadata, and wherein the second value is equal to one of the one or more values of the second metadata associated with the region of the B axis.

5. A method according to claim 4,
wherein the point in the region of the B axis is associated with the one of the one or more values of the second metadata which is equal to the second value.

6. A method according to claim 1,
wherein a size of the graphical indication is based on the second value.

7. A method according to claim 6,
wherein the second type of metadata comprises relevancy of the search result.

8. A method according to claim 6, further comprising:
receiving a second search result associated with a third value of the first type of metadata and a fourth value of the second type of metadata,
wherein creating the view comprises:
creating the view comprising a second graphical indication of the second search result at coordinates (A₂, B₂) of the coordinate system comprising axis A and axis B,
wherein the coordinate A₂ is based on the third value and the coordinate B₂ is based on the fourth value,
wherein coordinate B₂ is not equal to coordinate B₁,
wherein a size of the second graphical indication is based on the fourth value, and
wherein the size of the second graphical indication is different from the size of the graphical indication.

9. A method according to claim 1, further comprising:
receiving a second search result associated with a third value of the first type of metadata and a fourth value of the second type of metadata,
wherein creating the view comprises:
creating the view comprising a second graphical indication of the second search result at coordinates (A₂, B₂) of the coordinate system comprising axis A and axis B,
wherein the coordinate A₂ is based on the third value and the coordinate B₂ is based on the fourth value, and
wherein coordinate B₂ is not equal to coordinate B₁.

10. A method according to claim 1, wherein the search result is associated with a third value of a third type of metadata, and further comprising:
receiving a command to associate axis A with one or more values of the third type of metadata; and
creating a second view comprising a second graphical indication of the search result at coordinates (A₂, B₁) of the coordinate system comprising axis A and axis B,
wherein the coordinate A₂ is based on the third value and the B₁ coordinate is based on the second value.

11. A method comprising:
receiving a search result associated with a first value of a first type of metadata and a second value of a second type of metadata; and
creating a view comprising a graphical indication of the search result at coordinate A₁ of axis A,
wherein the coordinate A₁ is based on the first value and a size of the graphical indication is based on the second value.

12. A method according to claim 11,
wherein the coordinate A₁ is a point in a region of the A axis, wherein the region of the A axis is associated with one or more values of the first metadata, and wherein the first value is equal to one of the one or more values of the first metadata associated with the region of the A axis.

13. A method according to claim 12,
wherein the point in the region of the A axis is associated with the one of the one or more values of the first metadata which is equal to the first value.

14. A method according to claim 11, further comprising:
receiving a second search result associated with a third value of the first type of metadata and a fourth value of the second type of metadata,
wherein creating the view comprises:
creating the view comprising a second graphical indication of the second search result at coordinate A₂ of axis A,
wherein the coordinate A₂ is based on the third value,
wherein a size of the second graphical indication is based on the fourth value, and
wherein the size of the second graphical indication is different from the size of the graphical indication.

15. A method according to claim 14,
wherein the second type of metadata comprises search result relevancy.

16. A method according to claim 11, wherein the search result is associated with a third value of a third type of metadata, and further comprising:
receiving a command to associate axis A with one or more values of the third metadata; and
creating a second view comprising a second graphical indication of the search result at coordinate A₂ of axis A,
wherein the coordinate A₂ is based on the third value, and
wherein a size of the second graphical indication is based on the second value.

17. A method according to claim 11, wherein the search result is associated with a third value of a third type of metadata, and further comprising:
receiving a command to associate a graphical indication size with the third type of metadata; and
creating a second view comprising a second graphical indication of the search result at coordinate A₂ of axis A,
wherein the coordinate A₂ is based on the first value, and
wherein a size of the second graphical indication is based on the third value.

18. A computer-readable medium having stored thereon program code, the program code executable by a computer to:
receive a search result associated with a first value of a first type of metadata and a second value of a second type of metadata; and
create a view comprising a graphical indication of the search result at coordinates (A₁, B₁) of a coordinate system comprising axis A and axis B,
wherein the coordinate A₁ is based on the first value and the coordinate B₁ is based on the second value.

19. A medium according to claim 18,
wherein a size of the graphical indication is based on the second value.

20. A method according to claim 19,
wherein the second type of metadata comprises relevancy of the search result.

21. A medium according to claim 19, the program code further executable by a computer to:
receive a second search result associated with a third value of the first type of metadata and a fourth value of the second type of metadata; and
create the view comprising a second graphical indication of the second search result at coordinates (A₂, B₂) of the coordinate system comprising axis A and axis B,
wherein the coordinate A₂ is based on the third value and the coordinate B₂ is based on the fourth value,
wherein coordinate B₂ is not equal to coordinate B₁,
wherein a size of the second graphical indication is based on the fourth value, and
wherein the size of the second graphical indication is different from the size of the graphical indication.

22. A medium according to claim 18, the program code further executable by a computer to:
receive a second search result associated with a third value of the first type of metadata and a fourth value of the second type of metadata;
create the view comprising a second graphical indication of the second search result at coordinates (A₂, B₂) of the coordinate system comprising axis A and axis B,
wherein the coordinate A₂ is based on the third value and the coordinate B₂ is based on the fourth value, and
wherein coordinate B₂ is not equal to coordinate B₁.

23. A method according to claim 18, wherein the search result is associated with a third value of a third type of metadata, and the program code further executable by a computer to:
receive a command to associate axis A with one or more values of the third type of metadata; and
create a second view comprising a second graphical indication of the search result at coordinates (A₂, B₁) of the coordinate system comprising axis A and axis B,
wherein the coordinate A₂ is based on the third value and the coordinate B₁ is based on the second value.

24. A computer-readable medium having stored thereon program code, the program code executable by a computer to:
receive a search result associated with a first value of a first type of metadata and a second value of a second type of metadata; and
create a view comprising a graphical indication of the search result at coordinate A₁ of axis A,
wherein the coordinate A, is based on the first value and a size of the graphical indication is based on the second value.

25. A medium according to claim 24, the program code further executable by a computer to:
receive a second search result associated with a third value of the first type of metadata and a fourth value of the second type of metadata;
create the view comprising a second graphical indication of the second search result at coordinate A₂ of axis A,
wherein the coordinate A₂ is based on the third value,
wherein a size of the second graphical indication is based on the fourth value, and
wherein the size of the second graphical indication is different from the size of the graphical indication.

26. A medium according to claim 24, the program code further executable by a computer to:
receive a command to associate a graphical indication size with the third type of metadata; and
create a second view comprising a second graphical indication of the search result at coordinate A₂ of axis A,
wherein the coordinate A₂ is based on the first value, and
wherein a size of the second graphical indication is based on the third value.
